(19) United States
(12) Patent Application Publication
(10) Pub. No.: US 2023/0090624 A1
(43) Pub. Date: Mar. 23, 2023

(54) SIDE-CHAIN FUNCTIONALIZED POLY (ARYL ETHER SULFONES) COPOLYMER COMPRISING REACTIVE END-GROUPS

(71) Applicant: SOLVAY SPECIALTY POLYMERS USA, LLC, Alpharetta, GA (US)

(72) Inventor: Kamlesh NAIR, Alpharetta, GA (US)

(21) Appl. No.: 17/784,124

(22) PCT Filed: Dec. 21, 2020
(86) PCT No.: PCT/EP2020/087370

§ 371 Date: Jun. 10, 2022

Related U.S. Application Data
(60) Provisional application No. 62/950,289, filed on Dec. 19, 2019.

(30) Foreign Application Priority Data
Mar. 10, 2020 (EP) 20162149.7

(51) Int. Cl. C08G 75/23; C08L 81/06; C08L 63/00

(52) U.S. Cl. CPC C08G 75/23; C08L 81/06; C08L 63/00; C08G 2150/00

(57) ABSTRACT

The invention pertains to a side-chain functionalized copolymer (P1) comprising reactive end-groups. The present invention also pertains to the preparation process of copolymer (P1) starting from copolymer (P0), as well as to the use of the copolymer (P1) in the preparation of a membrane, a composite material or a coating. The present invention also relates to a resin composition comprising at least the copolymer (P1) according to the present invention.

### RELATED APPLICATIONS

This application claims priority to U.S. provisional application U.S. 62/944,121 filed on 19 Dec. 2019 and to European patent application EP 20162138.0 filed on Mar. 10, 2020, the whole content of these applications being incorporated herein by reference for all purposes.

### TECHNICAL FIELD

The present invention relates to a side-chain functionalized copolymer (P1) comprising reactive end-groups and to the process for preparing this copolymer (P1) starting from copolymer (P0), which is also an object of the present invention. The present invention also pertains to the use of the copolymer (P1) in the preparation of a membrane, a composite material or a coating, as well as to a resin composition comprising at least the copolymer (P1) according to the present invention.

### BACKGROUND ART

Poly(aryl ether sulfones) (PAES) polymers are highly thermally stable polymers with excellent toughness and impact strength. These resins are made by polycondensation reactions, typically using 4,4′-dichlorodiphenyl sulfone (DCDPS) along with other aromatic diols such as bisphenol A (BPA), 4,4′-biphenol (BP) or 4,4′-dihydroxydiphenylsulfone (DHDPS, also called bisphenol S or BPS).

PAES are used as toughening agents in epoxy resin composites. The toughness or the impact properties of the composite can be enhanced by increasing the amount of PAES in the matrix. However, these polymers have poor solubility in the epoxy composite matrix, which makes difficult the incorporation of PAES polymers into epoxy composite matrix.

To overcome the above problem, PAES featuring reactive end-groups, which possess a lighter solubility than PAES as such, have been used to improve interfacial properties in epoxy resins. For example, US2014/329973 (Solvay) describes epoxy resin compositions comprising epoxy resins, one curing agent, one accelerator and at least two PAES polymers presenting distinct reactive end-groups.

While such PAES containing reactive end-groups have been shown to have a better solubility and reactivity with the epoxy resin as compared to other PAES, there is a limit to which they can be added to the epoxy composite matrix, thereby limiting their beneficial effect in composite applications.

One object of the present invention is to further improve the impact properties and toughness of composite materials, by increasing the amount of PAES into the epoxy matrix. This object is solved by incorporating in the matrix of such composite materials the side-chain functionalized PAES copolymer (P1), object of the present invention.

Such an approach of polymer side-chain functionalization has been reported in the literature: the preparation and use of side-chain functionalized poly(ether ether ketone) (PEEK) polymers are described in several articles.

The article of NI JING et al. (J. Mater. Chem, 2010, 20, 6352-6358) relates to crosslinked hybrid membranes based on sulfonated poly(ether ether ketone) (PEEK). This article describes the preparation of a copolymer comprising PEEK recurring units, some of them being sulfonated, starting from diallyl bisphenol A (daBPA), 4,4-Difluorobenzophenone (DFB) and 5,5-Carbonyl-bis(2-fluoro benzenesulfonate) (SDFR) and the preparation of membranes starting from this copolymer, as well as phosphotungstic acid (PWA) and 3-methacryloxypropyltrimethoxysilane (KH570).

The article of XUEHONG HUANG et al. (Applied Surface Science 258, 2012, 2312-2318) relates to the synthesis of side-chain-type ion exchange membrane. This article describes the preparation of a copolymer starting from DFB, bisphenol A and diallyl bisphenol A, and the grafting reaction of this copolymer is the presence of sodium sulfonic styrene and KH570.

The article of DING F C et al. (Journal of Power Sources 170, 2007, 20-27) relates to the fabrication of cross-linked sulfonated fluorene-containing PEEK for proton exchange membrane, using diallyl biphenol (daBP).

U.S. Pat. No. 5,212,264 (Ciba) relates to substantially linear PAES polymers having specific segments in the backbone. According to the examples, the PAES is prepared from a mixture of DHDPS with DCDPS (example A) and reacted with bisphenol A diglycidyl ether (BGEBPA), thereby describing the synthesis of a semi-aromatic/semi-aliphatic block copolymer consisting of polyarylethersulfone blocks and glycidyl ether groups. The polymer presents aliphatic hydroxyl groups as pendant side-chains which arise from the reaction of the phenolic end-groups and the epoxy agent. The concentration of these groups is less than 100 microequivalents/g. This document does not describe the synthesis of a linear polymer with a completely aromatic backbone functionalized with side-chains in the meaning of the present invention. The inventors hereby demonstrate that the crosslinking reactivity of such copolymers is not comparable to the one of the copolymers of the present invention.

However, these articles do not describe the copolymer of the present invention which comprises the structure described in details below, as well and at least 50 μeq of hydroxyl, amine or acid reactive end-groups. These articles do not describe either the use of such copolymer as toughening agents for epoxy resin compositions.

### SUMMARY OF INVENTION

A first aspect of the present disclosure is directed to a side-chain functionalized poly(aryl ether sulfones) (PAES) copolymer (P1). This copolymer (P1) comprises:
PAES recurring units (R_{P1}),
PAES recurring units with pendant groups (R*_{P1}), more precisely PAES recurring units functionalized with side-chain groups, and
at least 50 μeq of hydroxyl end groups, amine end groups or acid end groups.

The present invention also relates to a process for preparing these copolymers (P1) from a copolymer (P0) bearing reactive end-groups and allyl/vinylene side-chains (i.e. unsaturated carbon-carbon double bonds functional groups). The present invention therefore provides a way to introduce both side-chain functionality and end-groups in the PAES polymers. The resulting copolymers can then be used in various applications, for example in composite materials in order to improve the mechanical properties (e.g. impact properties and toughness) of composite materials.

The present invention also relates to the copolymer (P0) itself, as an intermediate to copolymer (P1), bearing reactive end-groups and allyl/vinylene side-chains.

The present invention also relates to the use of the copolymer (P0) in composite materials.

### DISCLOSURE OF THE INVENTION

The present chemistry can notably be used to increase the solubility of the PAES in certain materials (e.g. epoxy resins, polyurethane resins or unsaturated polyesters), as well as to increase the bonding between components in a composition of matter, for example comprising polymers and/or inorganic fillers (e.g. glass fibers). Increasing the interactions between the components of a composition improves the mechanical performance of the material, for example the polymeric component and the inorganic fillers in a composite material.

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

Copolymer (P1)

The present invention relates to a side-chain functionalized copolymer (P1).

This copolymer (P1) comprises at least two types of recurring units, namely recurring units (R_{P1}) of formula (M) and recurring units (R*_{P1}) of formula (N), described below, as well as at least 50 μeq of hydroxyl, amine or acid end-groups.

The functional groups of copolymer (P1) are internal functionalizations, within the copolymer backbone. The internal functionalizations result from a step-growth polymerization, in the presence of an allyl-substituted monomer, which advantageously makes the system versatile as the content of functionality can be adjusted by varying the content of allyl-substituted monomer in the reaction mixture. The allyl-substituted monomer comprises two pendant allyl group side chains which according to the present invention each comprises from 3 to 7 carbon atoms.

The copolymer (P1) of the present invention at least comprises:
recurring units (R_{P1}) of formula (M):

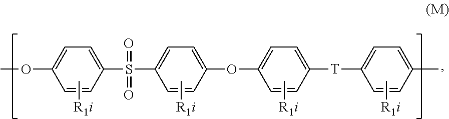

recurring units (R*_{P1}) of formula (N):

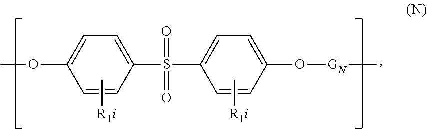

wherein
   G_{N} is selected from the group consisting of at least one of the following formulas:

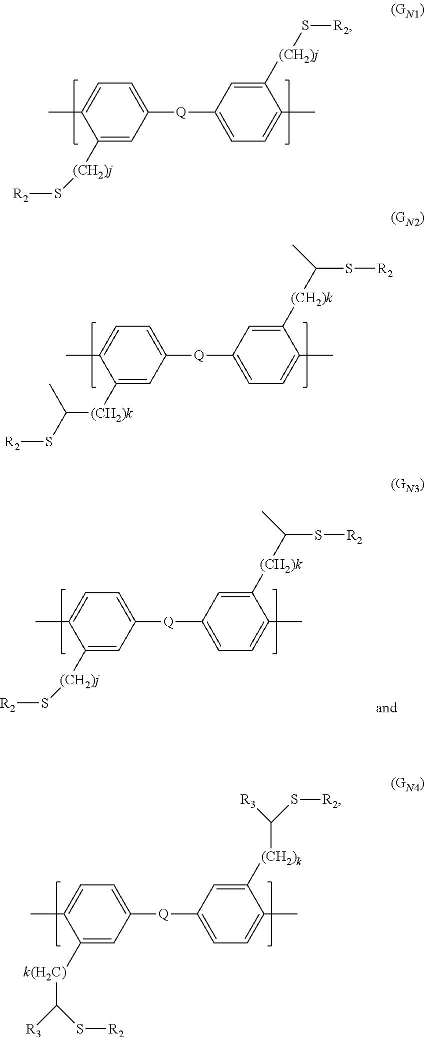

each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently selected from 0 to 4;
each k is independently selected from 1 to 4;
each j is independently selected from 3 to 7; and
T and Q are independently selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
each R₃ is independently an alkyl group, an aryl group or an halogen group,
each R₂ is independently selected from the group consisting of:
   —(CH₂)u-COOH, with u being selected from 1 to 5,
   —(CH₂)k-OH, with k being selected from 1 to 5,
   —(CH₂)p-NRₐR_{b}, with p being selected from 1 to 5, and a and b being independently a C1-C6 alkyl or H, with the proviso that Rₐ and R_{b} cannot be both CH₃,
   —(CH₂)q-SO₃Na, with q being selected from 1 to 5,
   —(CH₂)a-COCH₃, with a being selected from 0 to 10
   —(CH₂)r-Si(OCH₃)₃, with r being selected from 1 to 5,
   —(CH₂)s-(CF₂)t-CF₃, with s being selected from 1 to 5 and t being selected from 1 to 10,
   —CO—R_{c}, with R_{c} being a C1-C6 alkyl or H, preferably H,
   —(CH₂)v-CH₃, with v being selected from 5 to 30, and
   —(CH₂)w-Ar, with w being selected from 0 to 10 and Ar comprising 1 to 10 one or two aromatic or heteroaromatic rings, for example one or two benzene rings, wherein Ar is possibly substituted with NRₐR_{b}, for example NH₂.

The copolymer (P1) of the present invention is in the form of a racemate product. Due to the presence of the base and high temperature during polymerization, the allyl-substituted monomer usually racemizes during polymerization in such a way that the position of the double bond may change along the side chains. This leads to the formation of molecules differing from each other by the fact that the double bond may be at the end of the side chain or one carbon before the end of the side chain. The amount of racemization depends on the reaction time and temperature.

The copolymer (P1) of the present invention may preferably be such that it comprises at least 50 mol. % of recurring units (R_{P1}) of formula (M), based on the total number of moles in the copolymer (P1), for example at least 55 mol. % or at least 60 mol. %.

The copolymer (P1) of the present invention may preferably comprise collectively at least 50 mol. % of recurring units (R_{P1}) and (R*_{P1}), based on the total number of moles in the copolymer (P1). The copolymer (P1) may for example comprise collectively at least 60 mol. %, at least 70 mol. %, at least 80 mol. %, at least 90 mol. %, at least 95 mol. %, at least 99 mol. % of recurring units (RN) and (R*_{P1}), based on the total number of moles in the copolymer (P1). The copolymer (P1) may even preferably consists essentially in recurring units (RN) and (R*_{P1}).

In some embodiments, the copolymer (P1) is such that R₂ in recurring units (R*_{P1}) is independently selected from the group consisting of:
—CH₂—COOH,
—(CH₂)₂—OH,
—(CH₂)₂—NH₂,
—(CH₂)₃—SO₃Na,
—(CH₂)₃—Si(OCH₃)₃,
—(CH₂)₂—(CF₂)₇—CF₃ (or any other fluoroalkyl group),
—C═O—H,
—(CH₂)₉—CH₃ (or any other alkyl group),
—CH₂-Ph, with Ph being benzene (or any other aromatic group), and
-Ph-NH₂, with Ph being benzene (or any other aromatic group).

In some embodiments, the copolymer (P1) is such that it comprises:
recurring units (R*_{P1}) wherein the group G_{N} is according to formula (G_{N1}), preferably at least 25 mol. % of the recurring units (R*_{P1}) are such that the group G_{N} is according to formula (G_{N1}), more preferably at least 30 mol. %, even more preferably 35 mol. %;
recurring units (R*_{P1}) wherein the group G_{N} is according to formulas (G_{N1}) and (G_{N3}), preferably at least 35 mol. % of the recurring units (R*_{P1}) are such that the group G_{N} is according to formula (G_{N1}) and (G_{N3}), more preferably at least 40 mol. %, even more preferably 45 mol. %; or
at least recurring units (R*_{P1}) wherein the group G_{N} is according to formulas (G_{N1}), (G_{N2}) and (G_{N3}), preferably at least 50 mol. % of the recurring units (R*_{P1}) are such that the group G_{N} is according to formula (G_{N1}) and (G_{N3}), more preferably at least 60 mol. %, even more preferably 70 mol. %, 80 mol. % or 90 mol. %.

In some embodiments, the copolymer (P1) is such that T in recurring units (R_{P1}) is selected from the group consisting of a bond, —SO₂—, —C(CH₃)₂— and a mixture therefrom. The copolymer (P1) of the present invention may, for example, comprise recurring units (R_{P1}) in which T is —C(CH₃)₂— and recurring units (R_{P1}) in which T is —SO₂—.

T in recurring units (R_{P1}) is preferably —C(CH₃)₂—.

In some embodiments, the copolymer (P1) is such that Q in (G_{N1}), (G_{N2}) and/or (G_{N3}) of recurring units (R*_{P1}) is selected from the group consisting of a bond, —SO₂—, —C(CH₃)₂— and a mixture therefrom.

In some preferred embodiments, G_{N} is selected from the group consisting of at least one of the following formulas:

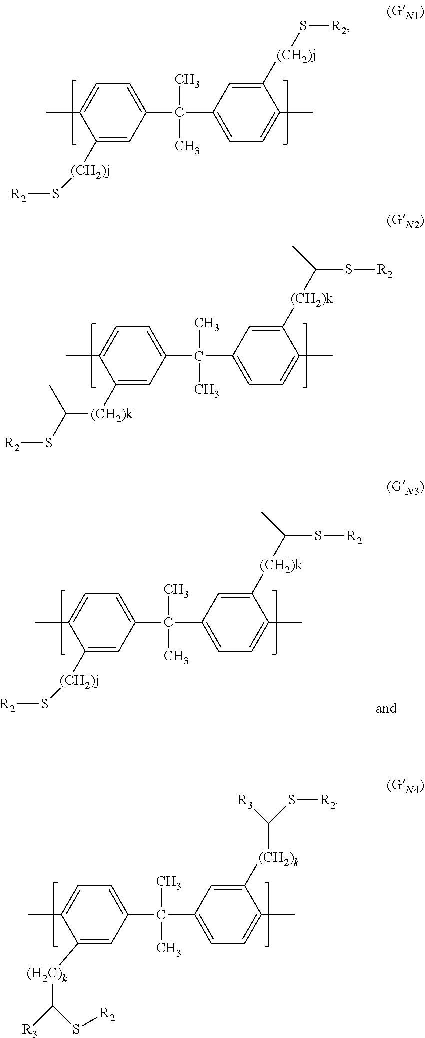

In some embodiments, the copolymer (P1) is such that each R₁ is independently selected from the group consisting of a C1-C12 moiety optionally comprising one or more than one heteroatoms; sulfonic acid and sulfonate groups; phosphonic acid and phosphonate groups; amine, amide and quaternary ammonium groups.

In some embodiments, the copolymer (P1) is such that i is zero for each R₁ of recurring units (R_{P1}) and recurring units (R*_{P1}).

In some embodiments, the copolymer (P1) is such that k is zero and j is 3 in recurring units (R*_{P1}).

In some embodiments, the copolymer (P1) is such that the molar ratio of recurring units (R_{P1})/recurring units (R*_{P1}) varies between 0.01/100 and 100/0.01, preferably between 1/100 and 100/1, more preferably between 1/1 and 12/1, even more preferably between 4/1 and 10/1.

In some embodiments, the copolymer (P1) is such that recurring units (R_{P1}) are according to formula (M1):

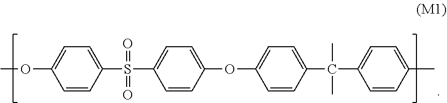

According to an embodiment, the copolymer (P1) of the present invention has a Tg ranging from 120 and 250° C., preferably from 170 and 240° C., more preferably from 180 and 230° C., as measured by differential scanning calorimetry (DSC) according to ASTM D3418.

End Groups

The polymer (P1) of the present invention is also characterized by the fact that it comprises at least 50 μeq of hydroxyl end groups, amine end groups or acid end groups, for example at least 80 μeq of these end groups, at least 100 μeq, at least 150 μeq or even at least 200 μeq of these end groups.

The polymer (P1) of the present invention may comprise less than 800 μeq of hydroxyl, amine or acid end groups, for example less than 600 μeq of these end groups.

The end groups are moieties at respective ends of the PAES polymer chain.

Depending on the method used for making the polymer (P1), and the possible use of an additional agent during the condensation process, for example an end-capping agent (e.g. aminophenol), or the possible addition of a protonating agent (e.g. oxalic acid) after the polymerization (in order to obtain phenolic —OH end groups), P1 may possess, for example, end groups derived from the monomers and/or end groups from derived from the end-capping agents. P1 is generally manufactured by a polycondensation reaction between a dihydroxy component and a dihalo component, so that the end groups usually include hydroxyl groups and halo-groups (such as chlorinated end groups or fluorinated end groups); however, when for example an end-capping agent such as aminophenol is used, the remaining halo-groups may be at least partially converted into amine end groups. The concentration of acid, amine and hydroxyl end groups can be determined by titration. The concentration of halogen groups can be determined with a halogen analyzer. The methods are detailed in the examples below. Nevertheless, any suitable method may be used to determine the concentration of the end groups. For example, titration, NMR, FTIR or a halogen analyzer may be used.

According to an embodiment, the polymer (P1) comprises at least 50 μeq/g of hydroxyl end groups (OH, μeq/g), for example at least 80 μeq of hydroxyl end groups, at least 100 μeq, at least 150 μeq or even at least 200 μeq of hydroxyl end groups.

According to an embodiment, the polymer (P1) comprises at least 1.16 OH in 100 repeating units of the polymer (P1), for example at least 1.86, at least 2.32 or at least 3.48 OH in 100 repeating units of the polymer (P1).

According to an embodiment, the polymer (P1) comprises at least 50 μeq/g of amine end groups (OH, μeq/g), for example at least 80 μeq of hydroxyl end groups, at least 100 μeq, at least 150 μeq or even at least 200 μeq of hydroxyl end groups.

According to an embodiment, the polymer (P1) comprises at least 50 μeq/g of acid end-groups (OH, μeq/g), for example at least 80 μeq of acid end groups, at least 100 μeq, at least 150 μeq or even at least 200 μeq of acid end groups.

Process for Preparing Copolymer (P1)

The copolymer (P1) can be prepared by various chemical processes, notably by free radical-thermal reaction, by free radical-UV reaction, by base-catalysed reaction or by nucleophilic-catalysed reaction.

The process for preparing copolymer (P1) comprises reacting an allyl/vinylene-functionalized copolymer (P0) with a compound R₂—SH, wherein R₂ is independently selected from the group consisting of:
—(CH₂)u-COOH, with u being selected from 1 to 5, preferably u being 1 or 2,
—(CH₂)k-OH, with k being selected from 1 to 5, preferably k being 1 or 2,
—(CH₂)p-NRₐR_{b}, with p being selected from 1 to 5, and a and b being independently a C1-C6 alkyl or H, with the proviso that Rₐ and R_{b} cannot be both CH₃; p being preferably 1 or 2, and Rₐ and R_{b} being preferably CH₃ or H,
—(CH₂)q-SO₃Na, with q being selected from 1 to 5, preferably q being 1, 2 or 3,
—(CH₂)a-COCH₃, with a being selected from 0 to 10,
—(CH₂)r-Si(OCH₃)₃, with r being selected from 1 to 5, preferably r being 1, 2 or 3,
—(CH₂)s-(CF₂)t-CF₃, with s being selected from 1 to 5, preferably 1 or 2, and t being selected from 1 to 10, preferably between 5 to 9, and
—CO—R_{c}, with R_{c} being a C1-C6 alkyl or H, preferably H,
—(CH₂)v-CH₃, with v being selected from 5 to 30, preferably v being selected from 8 to 20, and
—(CH₂)w-Ar, with w being selected from 0 to 10 and Ar comprises one or two aromatic or heteroaromatic rings, for example one or two benzene rings, with Ar being possibly substituted with —NRₐR_{b}, and Rₐ and R_{b} being preferably CH₃ or H.

The copolymer (P0), used in the process of the present invention, which is also one object of the present invention, notably comprises recurring units (R*_{P0}) with 2 pendant allyl/vinylene side-chains, which are reactive with the compound R₂— SH. The copolymer (P0) more precisely comprises:
recurring units (R_{P0}) of formula (M):

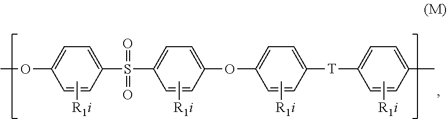

recurring units (R*_{P0}) of formula (P):

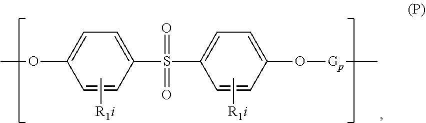

at least 50 μeq of hydroxyl end groups, amine end groups or acid end groups,
wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each i is independently selected from 0 to 4;
   T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
   G_{P} is selected from the group consisting of at least one of the following formulas:

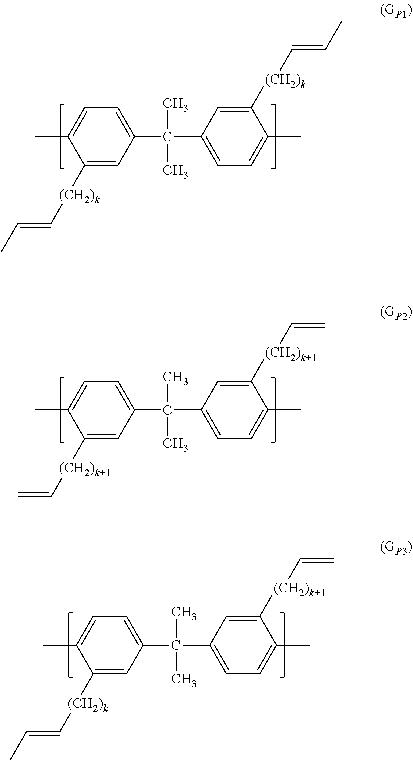

each k is independently selected from 0 to 4.

In some embodiments, the copolymer (P0) is such that k is zero in recurring units (R*_{P0}).

The reaction to prepare copolymer (P1) is preferably carried out in a solvent. When the reaction to prepare copolymer (P1) is carried out in a solvent, the solvent is for example a polar aprotic solvent selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole and sulfolane. The solvent may also be chloroform or dichloromethane (DCM). The reaction to prepare copolymer (P1) is preferably carried out in sulfolane or NMP.

The molar ratio of compound (I)/polymer (P0) varies between varies between 0.01/100 and 100/0.01, preferably between 1/100 and 100/1, more preferably between 1/1 and 10/1.

The temperature of the reaction to prepare copolymer (P1) varies between 10° C. and 300° C., preferably between room temperature and 200° C., or more preferably between 35° C. and 100° C.

The process to prepare copolymer (P1) may be carried out by exposing the reaction mixture to UV light at a wavelength ranging from 300 nm to 600 nm, preferably from 350 nm to 450 nm, more preferably at 365 nm.

In some embodiments, the copolymer (P0) is such that T in recurring units (R_{P0}) is selected from the group consisting of a bond, —SO₂—, —C(CH₃)₂— and a mixture therefrom. The copolymer (P0) may, for example, comprise recurring units (R_{P0}) in which T is —C(CH₃)₂— and recurring units (R_{P1}) in which T is —SO₂—.

T in recurring units (R_{P0}) is preferably —C(CH₃)₂—.

In some embodiments, the copolymer (P0) is such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In some embodiments, the copolymer (P0) is such that i is zero for each R₁ of recurring units (R_{P0}) and recurring units (R*_{P0}).

In some embodiments, the copolymer (P0) is such that j is 2 in recurring units (R_{P0}).

In some embodiments, the copolymer (P0) is such that the molar ratio of recurring units (R_{P0})/recurring units (R*_{P0}) varies between 0.01/100 and 100/0.01, preferably between 1/100 and 100/1.

In some embodiments, the copolymer (P0) is such that recurring units (R_{P0}) are according to formula (M1):

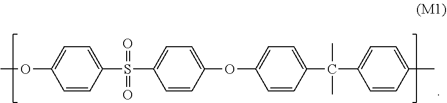

In some embodiments, the copolymer (P0) comprises collectively at least 50 mol. % of recurring units (R_{P0}) and (R*_{P0}), based on the total number of moles in the copolymer (P0). The copolymer (P0) may for example comprise collectively at least 60 mol. %, at least 70 mol. %, at least 80 mol. %, at least 90 mol. %, at least 95 mol. %, at least 99 mol. % of recurring units (R_{P0}) and (R*_{P0}), based on the total number of moles in the copolymer (P0). The copolymer (P0) may preferably consists essentially in recurring units (R_{P0}) and (R*_{P0}).

According to an embodiment, the copolymer (P0) of the present invention has a Tg ranging from 120 and 250° C., preferably from 170 and 240° C., more preferably from 180 and 230° C., as measured by differential scanning calorimetry (DSC) according to ASTM D3418.

In some embodiments, the compound R₂— SH used to react the copolymer (P0) is such that R₂ in recurring units (R*_{P1}) is independently selected from the group consisting of:
—CH₂—COOH,
—(CH₂)₂—OH,
—(CH₂)₂—NH₂,
—(CH₂)₃—SO₃N a,
—(CH₂)₃—Si(OCH₃)₃,
—(CH₂)₂—(CF₂)₇—CF₃, and
—C═O—H,
—(CH₂)₉—CH₃, and
—CH₂-Ph, with Ph being benzene.

In some embodiments, the reaction to prepare copolymer (P1) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base may also be selected from the group consisting of N-Ethyl-N-(propan-2-yl)propan-2-amine (Hunig base), triethylamine (TEA) and pyridine.

In some embodiments, the reaction to prepare copolymer (P1) may be carried out in the presence of:
at least one free radical initiator, preferably 2,2′-Azobis(2-methylpropionitrile) (AIBN), and/or
at least one catalyst, preferably selected from peroxides and hydroperoxides.

According to an embodiment, the amount of copolymer (P1) at the end of the reaction is at least 10 wt. % based on the total weight of the copolymer (P0) and the solvent, for example at least 15 wt. %, at least 20 wt. % or at least 30 wt. %.

At the end of the reaction, the copolymer (P1) is separated from the other components (salts, base, . . . ) to obtain a solution. Filtration can for example be used to separate the copolymer (P1) from the other components. The solution can then be used as such for reacting the copolymer (P1) with other compounds, or alternatively, the copolymer (P1) can be recovered from the solvent, for example by coagulation or devolatilization of the solvent.

The polymer (P0) of the present invention is also characterized by the fact that it comprises at least 50 μeq of hydroxyl end groups, amine end groups or acid end groups, for example at least 80 μeq of these end groups, at least 100 μeq, at least 150 μeq or even at least 200 μeq of these end groups. Hydroxyl, amine or acid end groups may be measured by titration as discussed above, or any other method available to the skilled person in the art.

Process for Preparing Copolymer (P0)

In some embodiments, the allyl/vinylene-functionalized copolymer (P0) used in the process of the present invention has been prepared by condensation of at least one aromatic dihydroxy monomer (a1), with at least one aromatic sulfone monomer (a2) comprising at least two halogen substituents and at least one allyl-substituted aromatic dihydroxy monomer (a3), as well as an additional agent, for example an end-capping agent or a protonating agent.

The condensation to prepare copolymer (P0) is preferably carried out in a solvent. When the condensation to prepare copolymer (P0) is carried out in a solvent, the solvent is for example a polar aprotic solvent selected from the group consisting of N-methylpyrrolidone (NMP), N-butylpyrrolidone (NBP), N,Ndimethylformamide (DMF), N,N dimethylacetamide (DMAC), 1,3-dimethyl-2-imidazolidinone, tetrahydrofuran (THF), dimethyl sulfoxide (DMSO), chlorobenzene and sulfolane. The condensation to prepare copolymer (P0) is preferably carried out in sulfolane or NMP.

The condensation to prepare copolymer (P0) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base acts to deprotonate the components (a1) and (a3) during the condensation reaction.

The molar ratio (a1)+(a3)/(a2) may be from 0.9 to 1.1, for example from 0.92 to 1.08 or from 0.95 to 1.05.

In some embodiments, the monomer (a2) is a 4,4-dihalosulfone comprising at least one of a 4,4′-dichlorodiphenyl sulfone (DCDPS) or 4,4′ difluorodiphenyl sulfone (DFDPS), preferably DCDPS.

In some embodiments, the monomer (a1) comprises, based on the total weight of the monomer (a1), at least 50 wt. % of 4,4′ dihydroxybiphenyl (biphenol), at least 50 wt. % of 2,2-bis(4-hydroxyphenyl)propane (bisphenol A) or at least 50 wt. % of 4,4′ dihydroxydiphenyl sulfone (bisphenol S).

In some embodiments, the monomer (a3) comprises, based on the total weight of the monomer (a1), at least 50 wt. % of 2,2′-diallylbisphenol A (DABA).

According to the condensation to prepare copolymer (P0), the monomers of the reaction mixture are generally reacted concurrently. The reaction is preferably conducted in one stage. This means that the deprotonation of monomers (a1) and (a3) and the condensation reaction between the monomers (a1)/(a3) and (a2) takes place in a single reaction stage without isolation of the intermediate products.

According to an embodiment, the condensation is carried out in a mixture of a polar aprotic solvent and a solvent which forms an azeotrope with water. The solvent which forms an azeotrope with water includes aromatic hydrocarbons such as benzene, toluene, xylene, ethylbenzene, chlorobenzene and the like. It is preferably toluene or chlorobenzene. The azeotrope forming solvent and polar aprotic solvent are used typically in a weight ratio of from about 1:10 to about 1:1, preferably from about 1:5 to about 1:1. Water is continuously removed from the reaction mass as an azeotrope with the azeotrope forming solvent so that substantially anhydrous conditions are maintained during the polymerization. The azeotrope-forming solvent, for example, chlorobenzene, is removed from the reaction mixture, typically by distillation, after the water formed in the reaction is removed leaving the copolymer (P0) dissolved in the polar aprotic solvent.

The temperature of the reaction mixture to prepare copolymer (P0) is kept at about 150° C. to about 350° C., preferably from about 210° C. to about 300° C. for about one to 15 hours.

Depending on the method used for making the copolymer (P1), and the possible use of an additional agent during the condensation process, for example an end-capping agent (e.g. aminophenol) or an protonating agent (e.g. oxalic acid), copolymer (P0) possesses end groups derived from the monomers and/or end groups from derived from the end-capping or protonating agents. As the copolymer (P0) is generally manufactured by a polycondensation reaction between a dihydroxy component and a dihalo component, its end groups usually include hydroxyl groups and halo-groups (such as chlorinated end groups or fluorinated end groups). However, when for example an end-capping agent (e.g. aminophenol or similar amine functionalized phenols) is used, based on the stoichiometry of the starting monomers (i.e. excess of dihydroxy monomers or excess of dihalo monomers), the remaining halo-groups may be at least partially converted into amine end groups. If a protonating agent (e.g. oxalic acid, acetic acid and the like organic acids) is used, depending on the starting monomers stoichiometry used, the copolymer (P0) may possess hydroxyl end groups. The concentration of the end groups (i.e acid, amine and hydroxyl end groups) can be determined by titration. The concentration of halogen groups can be determined with a halogen analyzer. The methods are detailed in the examples below. Nevertheless, any suitable method may be used to determine the concentration of the end groups. For example, titration, NMR, FTIR or a halogen analyzer may be used.

The inorganic constituents, for example sodium chloride or potassium chloride or excess of base, can be removed, before or after isolation of the copolymer (P0), by suitable methods such as dissolving and filtering, screening or extracting.

According to an embodiment, the amount of copolymer (P0) at the end of the condensation is at least 30 wt. % based on the total weight of the copolymer (P0) and the polar aprotic solvent, for example at least 35 wt. % or at least or at least 37 wt. % or at least 40 wt. %.

At the end of the reaction, the copolymer (P0) is separated from the other components (salts, base, . . . ) to obtain a solution. Filtration can for example be used to separate the copolymer (P0) from the other components. The solution can then be used as such for reacting the copolymer (P0) with the compound R₂—SH in the process of the present invention, or alternatively, the copolymer (P0) can be recovered from the solvent, for example by coagulation or devolatilization of the solvent.

Applications

The copolymer (P1) of the present invention may be used in the preparation of functional membranes. For example, these membranes may be hydrophobic, hydrophilic, bio-labeled, for example membranes with fluorescent tags.

The copolymer (P1) of the present invention may also be used in the preparation of composite materials. In this application, the functionalities improve the adhesion of the resin to the reinforcing fibers thereby improving performance.

The copolymer (P1) of the present invention may also be used in the preparation of functional coatings. Chemical moieties on the surface of the coatings can be selected to make the coating hydrophobic, hydrophilic, bio-taggable, anti-microbial, anti-fouling and/or UV curable.

The present invention also relates to the use of the copolymer (P0) in the preparation of a membrane, a composite material or a coating, as well as to a resin composition comprising at least the copolymer (P0) as described above.

Resin Compositions

The resin composition of the present invention may be an epoxy resin, a polyurethane resin or an unsaturated polyester resin. The composition comprises at least one copolymer (P1) as described above and an additional component which can, for example, be at least one epoxy compound and/or a curing agent (for example polyalkylenepolyamines, such as ethylene diamine (EDA), diethylene triamine (DETA), triethylene tetramine (TETA), tetraethylene pentamine (TEPA), and polyethylene polyamines (PEPA)).

The term “epoxy component” means a compound that contains more than one epoxy group, preferably two epoxy groups, per molecule. These epoxy compounds may be either saturated or unsaturated and aliphatic, cycloaliphatic, aromatic or heterocyclic and may also have hydroxyl groups. They are preferably glycidyl ethers which derive from polyhydric phenols, especially bisphenols or aminophenols and novolacs.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLES

Raw Materials

DCDPS (4,4′-dichlorodiphenyl sulfone), available from Solvay Speciality Polymers

BPA (bisphenol A), available from Covestro, U.S.A.

BP (4,4′-biphenol), polymer grade available from Honshu Chemicals, Japan

daBPA (2,2′-diallyl Bisphenol), available from Sigma-Aldrich, U.S.A.

K₂CO₃ (Potassium Carbonate), available from Armand products

NaHCO₃(Sodium bicarbonate), available from Solvay S.A., France

NMP (2-methyl pyrrolidone), available from Sigma-Aldrich, U.S.A.

AIBN (Azobisisobutyronitrile), available from Sigma-Aldrich, U.S.A.

Cysteamine hydrochloride, 3-Aminophenol available from Sigma-Aldrich, U.S.A.

ADVN (2,2′-Azobis (2,4 dimethylvaleronitrile)), available from Miller-Stephenson Chemical Co., Inc.

Test Methods

GPC—Molecular weight (Mn, Mw)

The molecular weights were measured by gel permeation chromatography (GPC), using methylene chloride as a mobile phase. Two 5μ mixed D columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The number average molecular weight Mn, weight average molecular weight Mw, higher average molecular weight Mz, were reported.

Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen. The TGA values report the temperature of the onset of thermal decomposition.

¹H NMR

¹H NMR spectra were measured using a 400 MHz Bruker spectrometer with TCE or DMSO as the deuterated solvent. All spectra are reference to residual proton in the solvent.

DSC

DSC was used to determine glass transition temperatures (Tg) and melting points (Tm)—if present. DSC experiments were carried out using a TA Instrument Q100. DSC curves were recorded by heating, cooling, re-heating, and then re-cooling the sample between 25° C. and 320° C. at a heating and cooling rate of 20° C./min. All DSC measurements were taken under a nitrogen purge. The reported Tg and Tm values were provided using the second heat curve unless otherwise noted.

Hydroxyl Titration

Hydroxyl groups were analyzed by dissolving a sample of the polymer in 5 ml of sulfolane:monochlorobenzene (50:50). 55 ml of methylene chloride was added to the solution and the sample was titrated with tetrabutyl ammonium hydroxide in toluene potentiometrically using Metrohm Solvotrode electrode & Metrohm 686 Titroprocessor with Metrohm 665 Dosimat. There were three possible equivalence points. The first equivalence point was indicative of strong acid. The second equivalence point was indicative of sulfonic hydroxyls. The third equivalence point was indicative of phenolic hydroxyls. Total hydroxyl numbers were calculated as a sum of phenolic and sulfonic hydroxyls.

Amine Titration

A sample of 0.2 to 0.3 g of polymer was dissolved in 55 mL of methylene chloride with stirring. 15 mL of glacial acetic acid was added. The sample was then titrated potentionmetrically with 0.1N perchloric acid in acetic acid using a Metrohm Titrando 809 Titrator with a Metrohm Solvotrode electrode. Perchloric acid titrant reacts with basic groups in the sample and produces an endpoint in the potential curve when all base has been neutralized. Two blanks and one control sample were tested prior to testing samples. Two replicates were run for each sample. The results were reported only after duplicate analyses agree within 5% for base concentration values above 100 μeq/g or were within 10 μeq/g for values below 100 μeq/g.

Calculation of Base Concentration:

$$[ Sample base , μ eq / g ] = \frac{( N perchloric acid ) \times ( V percloric acid - V blank ) \times 1000}{W sample}$$

N perchloric acid=number of moles of perchloric acid (N)
V perchloric acid=volume of perchloric acid (mL)
V blank=volume of blank (mL)
W sample=weight of the sample (g)

The blank value is determined from the volume of titrant needed to achieve the same mV electrode potential as the sample titration endpoint potential.

Chlorine Analysis

Chlorine end groups were analysed using a ThermoGLAS 1200 TOX halogen analyzer. Samples between 1 mg and 10 mg were weighted into a quartz boat and inserted into a heated combustion tube where the sample was burned at 1,000° C. in an oxygen stream. The combustion products were passed through concentrated sulfuric acid scrubbers into a titration cell where hydrogen chloride from the combustion process was absorbed in 75% v/v acetic acid. Chloride entering the cell was then titrated with silver ions generated coulometrically. Percent chlorine in the sample was calculated from the integrated current and the sample weight. The resulting percent chlorine value was converted to chlorine end group concentration in micro equivalents per gram (μeq/g).

I. Preparation of Amine-Terminated, Allyl/Vinylene-Modified PSU Copolymer (P0-A)

The functionalized PSU polymer (P0-A) was prepared according to the Scheme 1.

The copolymerization takes place in a glass reactor vessel (2 L) fitted with an overhead stirrer, nitrogen inlet and an overhead distillation set-up. The monomers DCDPS (430.47 g), BPA (257.51 g) and daBPA (86.97 g) are added to the vessel first, followed by the addition of K₂CO₃ (212.41 g), NMP (900 g).

The reaction mixture is heated from room temperature to 190° C. using a 1° C./min heating ramp. The temperature of the reaction mixture is maintained for 4 hours. K₂CO₃ (36 g) and 3-aminophenol (18.33 g) are then added and the reaction is continued for 4 hours. The reaction is terminated by stopping the heating. The reaction mixture is filtered, coagulated into methanol and dried at 110° C.

The copolymer is in the form of a racemate product. Due to the presence of the base and high temperature during polymerization, the daBPA monomer racemizes during polymerization in such a way that the position of the double bond changes along the side chains. This leads to the formation of molecules differing from each other by the fact that the double bond may be at the end of the side chain or one carbon before the end of the side chain, as shown in Scheme 1.

Characterization

GPC: Mn=9,458 g/mol, Mw=24,952 g/mol, PDI=2.64

TGA: 397° C.

DSC: 160.5° C.

Amine groups: 212 μeq/g

¹H NMR: The presence of unsaturated groups was confirmed by the appearance of a multiplet at 6.1-6.4 ppm which indicates the incorporation of the daBPA monomer in the polymer.

II. Preparation of Phenolic-Hydroxyl-Terminated, Allyl/Vinylene-Modified PSU Copolymer (P0-B)

The functionalized PSU polymer (P0-B) was prepared according to the Scheme 2.

The copolymerization takes place in a glass reactor vessel (2 L) fitted with an overhead stirrer, nitrogen inlet and an overhead distillation set-up. The monomers DCDPS (430.47 g), BPA (257.51 g) and daBPA (86.97 g) are added to the vessel first, followed by the addition of K₂CO₃ (212.41 g), and NMP (900 g).

The reaction mixture is heated from room temperature to 190° C. using a 1°C/min heating ramp. The temperature of the reaction mixture is maintained for 4 hours. K₂CO₃ (24.87 g) and BPA (41 g) are added and then reaction is continued for 4 hours. The reaction is terminated by stopping the heating and oxalic acid (50 g) is added and stirred. The reaction mixture is filtered, coagulated into methanol and dried at 110° C.

Similarly to copolymer (P0-A), this copolymer (P0-B) is in the form of a racemate product.

Characterization

GPC: Mn=9,536 g/mol, Mw=24,327 g/mol, PDI=2.55

TGA: 411° C.

DSC: 154° C.

Hydroxyl: 210.7 μeq/g

Chlorine: 3.2 μeq/g

III. Preparation of Amine-Terminated, Allyl/Vinylene-Modified PPSU Copolymer (P0-A)

The functionalized PPSU polymer (P0-C) was prepared according to the Scheme 3.

The copolymerization takes place in a glass reactor vessel (2 L) fitted with an overhead stirrer, nitrogen inlet and an overhead distillation set-up. The monomers DCDPS (430.74 g), BPA (210.04 g) and daBPA (86.97 g) are added to the vessel first, followed by the addition of K₂CO₃ (204.61 g), and NMP (900 g).

The reaction mixture is heated from room temperature to 190° C. using a 1° C./min heating ramp. The temperature of the reaction mixture is maintained for 4 hours. K₂CO₃ (36 g) and 3-aminophenol (18.33 g) are then added and the reaction is continued for 4 hours. The reaction is terminated by stopping the heating. The reaction mixture is filtered, coagulated into methanol and dried at 110° C.

Similarly to copolymer (P0-A), this copolymer (P0-C) is in the form of a racemate product.

Characterization

GPC: Mn=11,425 g/mol, Mw=39,759 g/mol, PDI=3.48

TGA: 422° C.

DSC: 179.21° C.

Amine groups: 212 μeq/g

¹H NMR: The presence of unsaturated groups was confirmed by the appearance of a multiplet at 6.1-6.4 ppm which indicates the incorporation of the daBPA monomer in the polymer.

IV. Preparation of Amine-Terminated, Allyl/Vinylene-Modified PES Copolymer (P0-D) The functionalized PES polymer (P0-D) was prepared according to the Scheme 4.

The copolymerization takes place in a glass reactor vessel (1 L) fitted with an overhead stirrer, nitrogen inlet and an overhead distillation set-up. The monomers DCDPS (215.37 g), DHDPS (175.88 g) and daBPA (24.02 g) are added to the vessel first, followed by the addition of K₂CO₃ (101.72 g), NMP (340 g).

The reaction mixture is heated from room temperature to 190° C. using a 1° C./min heating ramp. The temperature of the reaction mixture is maintained for 4 hours. 3-aminophenol (18.33 g) is then added and the reaction is continued for 3 hours. The reaction is terminated by stopping the heating. The reaction mixture is filtered, coagulated into methanol and dried at 110° C.

Similarly to copolymer (P0-A), this copolymer (P0-D) is in the form of a racemate product.

Characterization

GPC: Mn=5,128 g/mol, Mw=9,550 g/mol, PDI=1.86

TGA: 426° C.

DSC: 187° C.

Amine groups: 227 μeq/g

¹H NMR: The presence of unsaturated groups was confirmed by the appearance of a multiplet at 6.1-6.4 ppm which indicates the incorporation of the daBPA monomer in the polymer.

V. Preparation of Functionalized PSU Copolymer (P1-A)

The functionalized PSU polymer (P1-A) was prepared according to the following procedure according to Scheme 5.

The amine functionalization takes place in a glass reactor vessel (1 L) fitted with an overhead stirrer, nitrogen inlet. Copolymer P0-A (100 g) and cysteamine hydrochloride (62.5 g) are dissolved at room temperature in NMP (900 g). The reaction mixture is purged with N₂ for at least 45 minutes, then the reaction is heated to 50° C. and ADVN (4 g) is added. The reaction is allowed to proceed for 12 hours, after which the heating is stopped. The reaction mixture is then coagulated in 3,000 mL in which 50 g of K₂CO₃ is added. The coagulated polymer is then washed with water (3,000 mL) and then washed twice with methanol (3,000 mL) and then dried at 110° C.

Characterization

GPC: Mn=4,060 g/mol, Mw=8,258 g/mol, PDI=2.03

TGA: 302° C.

DSC: 150° C.

Amine groups: 944 μeq/g

VI. Preparation of Functionalized PSU Copolymer (P1-B)

The functionalized PSU polymer (P1-B) was prepared according to the following procedure according to Scheme 6.

The amine functionalization takes place in a glass reactor vessel (1 L) fitted with an overhead stirrer, nitrogen inlet. Copolymer P0-B (50 g), cysteamine hydrochloride (48.1 g) are dissolved at room temperature in NMP (450 g). The reaction mixture is purged with N₂ for at least 45 minutes, then the reaction is heated to 50° C. and ADVN (2.9 g) is added. The reaction is allowed to proceed for 12 hours, after which the heating is stopped. The reaction mixture is then coagulated in 3,000 mL in which 50 g of K₂CO₃ is added. The coagulated polymer is then washed with water (3,000 mL) and then washed twice with methanol (3,000 mL) and then dried at 110° C.

Characterization

GPC: Mn=2,878 g/mol, Mw=6,253 g/mol, PDI=2.17

TGA: 386° C.

DSC: 143.16° C.

Amine groups: 699 μeq/g

VII. Preparation of Functionalized PPSU Copolymer (P1-C)

The functionalized PPSU polymer (P1-0) was prepared according to the following procedure according to Scheme 7.

The amine functionalization takes place in a glass reactor vessel (1 L) fitted with an overhead stirrer, nitrogen inlet. Copolymer P0-C (100 g), and cysteamine hydrochloride (62.5 g) are dissolved at room temperature in NMP (900 g). The reaction mixture is purged with N₂ for at least 45 minutes, then the reaction is heated to 50° C. and ADVN (4 g) is added. The reaction is allowed to proceed for 12 hours, after which the heating is stopped. The reaction mixture is then coagulated in 3000 mL in which 50 g of K₂CO₃ is added. The coagulated polymer is then washed with water (3,000 mL) and then washed twice with methanol (3,000 mL) and then dried at 110° C.

Characterization

GPC: Mn=3,321 g/mol, Mw=6,130 g/mol, PDI=1.85

TGA: 302° C.

DSC: 170.3° C.

Amine groups: 900 μeq/g

VIII. Preparation of Functionalized PES Copolymer (P1-D)

The functionalized PES polymer (P1-D) was prepared according to the following procedure according to Scheme 8.

The amine functionalization takes place in a glass reactor vessel (1 L) fitted with an overhead stirrer, nitrogen inlet. Copolymer P0-D (130 g), and cysteamine hydrochloride (63.6 g) are dissolved at room temperature in DMSO (640 g). The reaction mixture is purged with N₂ for at least 45 minutes, then the reaction is heated to 70° C. and AIBN (8 g) is added. The reaction is allowed to proceed for 12 hours, after which the heating is stopped. The reaction mixture is then coagulated in 3000 mL in which 50 g of K₂CO₃ is added. The coagulated polymer is then washed with water (3,000 mL) and then washed twice with methanol (3,000 mL) and then dried at 110° C.

Characterization

GPC: Mn=4,603 g/mol, Mw=8,038 g/mol, PDI=1.75

TGA: 190° C.

DSC: 470° C.

Amine groups: 369 μeq/g

IX. Preparation of Functionalized PSU Copolymer (P1-E)

The functionalized PSU polymer (P1-E) was prepared according to the following procedure according to Scheme 9.

The carboxylic acid functionalization takes place in a glass reactor vessel (1 L) fitted with an overhead stirrer, nitrogen inlet. Copolymer P0-A (120 g), and thioglycolic acid (13.81 g) are dissolved at room temperature in NMP (285 g). The reaction mixture is purged with N₂ for at least 45 minutes, then the reaction is heated to 70° C. and AIBN (8.2 g) is added. The reaction is allowed to proceed for 12 hours, after which the heating is stopped. The reaction mixture is then coagulated in 3,000 mL of methanol. The coagulated polymer is then washed twice with methanol (3,000 mL) and then dried at 110° C.

Characterization

GPC: Mn=8,065 g/mol, Mw=18,380 g/mol, PDI=2.28

TGA: 390° C.

DSC: 162° C.

Carboxylic acid groups: 315 μeq/g

X. Preparation of Crosslinked Materials

The copolymer of Example 13 of U.S. Pat. No. 5,212,264 (Ciba) has been reproduced and crosslinked with different amounts of epoxy compounds.

1. Synthesis of the Base Polymer

First the base polymer G was synthesized using the polymerization procedure explained in the patent.

Characterisation of the Polymer

Mw=78284 g/mol, Mn=28497 g/mol, PDI=2.75,

Chlorine end groups=45.6 ueq/g,

Phenolic end groups=6 ueq/g,

Relative viscosity=0.686375

Tg (DSC)=232.6° C.

2. Chain Extension Using Bisphenol a Diglycidyl Ether (BGEBPA)

Procedure: Take 160.71 g of the reaction mixture of the DPS polymerization reaction (which contains 75 g of polymer), in a 500 mL round bottom flask with an overhead stirrer and strong N₂ inflow. Heat the reaction mixture to 150° C. and then dropwise add 1.65 g of BGEBPA. Keep stirring this at 150° C. for 2 hours and then pour it on to a metal tray and crush it once it is cool. Dissolve the residue in the beaker with say 50 mL of NMP. Combine the residue and washings and then wash it three times with (acetone/water=80/20; 1 wash with water). Concentrated acetic acid is added during the aqueous extraction to liberate the OH end groups.

Characterisation of the Polymer

Mw=79,511 g/mol, Mn=32,458 g/mol, PDI=2.45,

Chlorine end groups=92.6 μeq/g,

Phenolic end groups=12.4 μeq/g,

Aliphatic side-chain hydroxyl groups (theoretical): 100.89 μeq/g

Tg (DSC)=226.73° C.

Relative viscosity=0.68481

3. Crosslinking of the Above Polymer with Araldite® MY 0510

Procedure: Dissolve 46 mg of Araldite® MY 0510 in 2 g of methylene chloride and then add it to 5 g of the chain extended PPSU. Shake this mixture so that the polymer is uniformly coated with the epoxy solution. Leave it to dry over 48 h in the hood at RT. Crosslink at 150° C. for 12 hours.

Results: When the above polymer is crosslinked with equimolar N,N-Diglycidyl-4-glycidyloxyaniline the Tg of the resultant crosslinked material was 229.16° C. This was an increase of 2.39° C. as compared to the uncrosslinked base polymer.

4. Crosslinking of the Copolymer P1-C of the Present Invention

Characterization of the Copolymer P1-C:

GPC: Mn=3,321 g/mol, Mw=6,130 g/mol, PDI=1.85

TGA: 302° C.

DSC: 170.3° C.

Amine groups (aliphatic amine side chain+aromatic amine end groups): 900 μeq/g

When the above polymer is crosslinked with equimolar amounts N,N-Diglycidyl-4-glycidyloxyaniline, the Tg of the resultant crosslinked material was 176.91° C. This was an increase of 6.61° C. as compared to the uncrosslinked base polymer.

The crosslinking experiment shows that the copolymer of the present invention has a denser network structure upon crosslinking as compared to the copolymer structure described in the prior art. This is attributed to the high concentrations of side-chain functional groups in the copolymer of the present invention, as compared to the copolymer described in U.S. Pat. No. 5,212,264 (Ciba). These copolymers depend upon an end-group chemistry which lead to copolymers having a reactivity which cannot be compared to the side-chain functionalization strategy of the present invention.

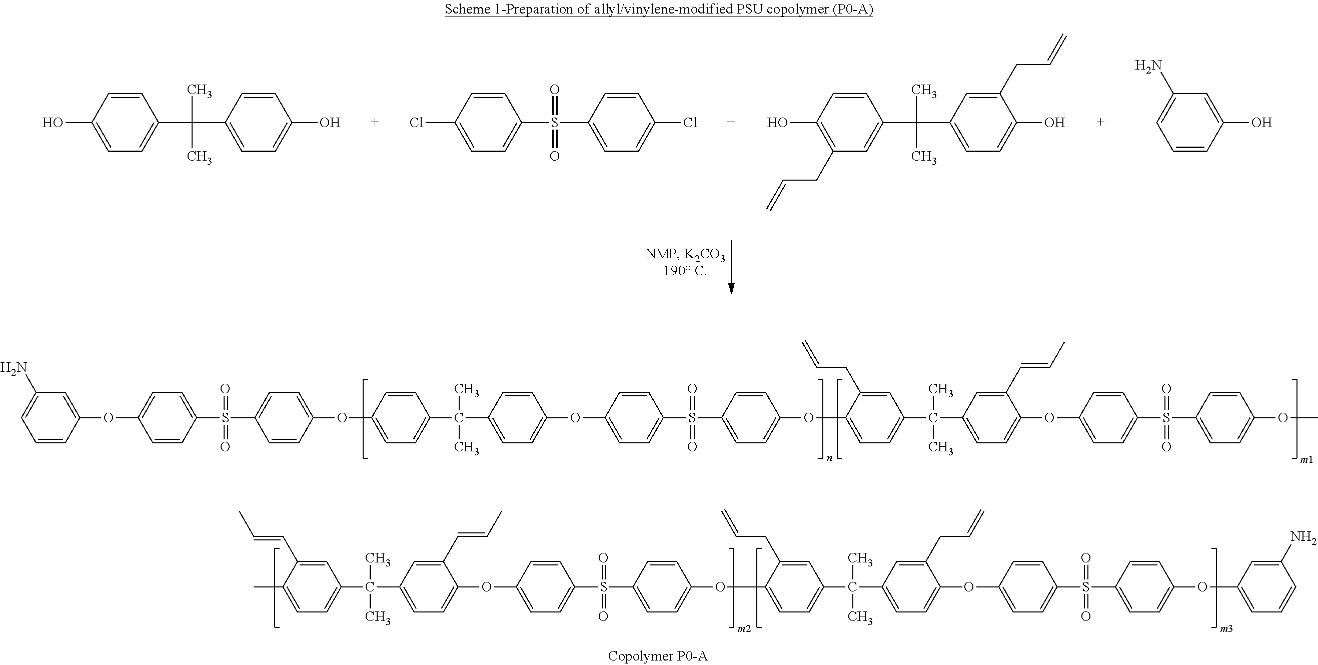

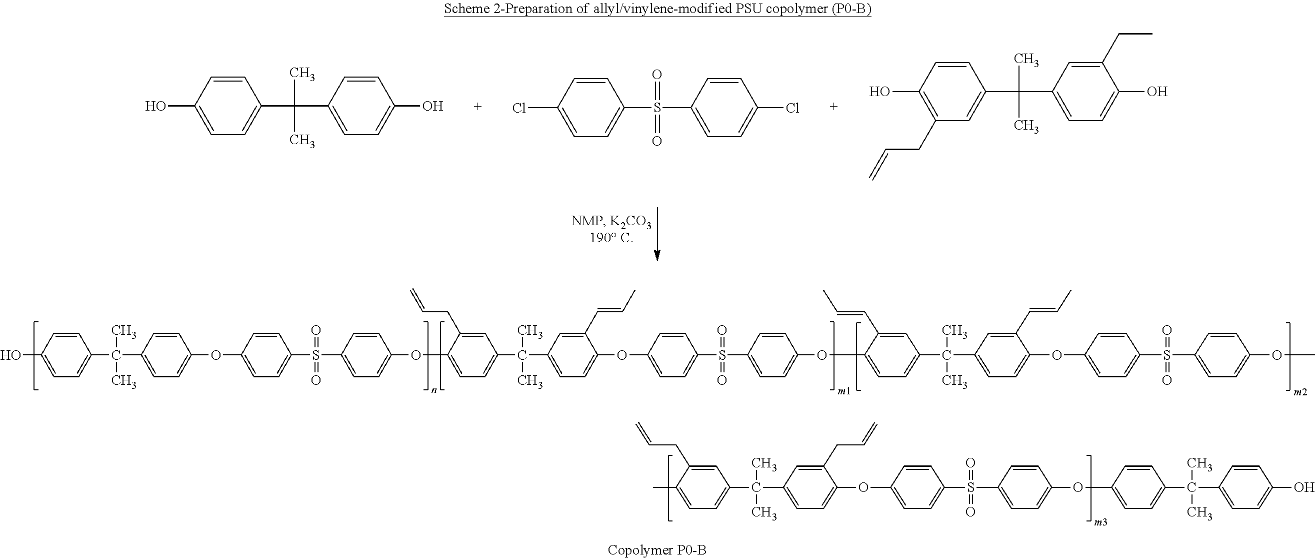

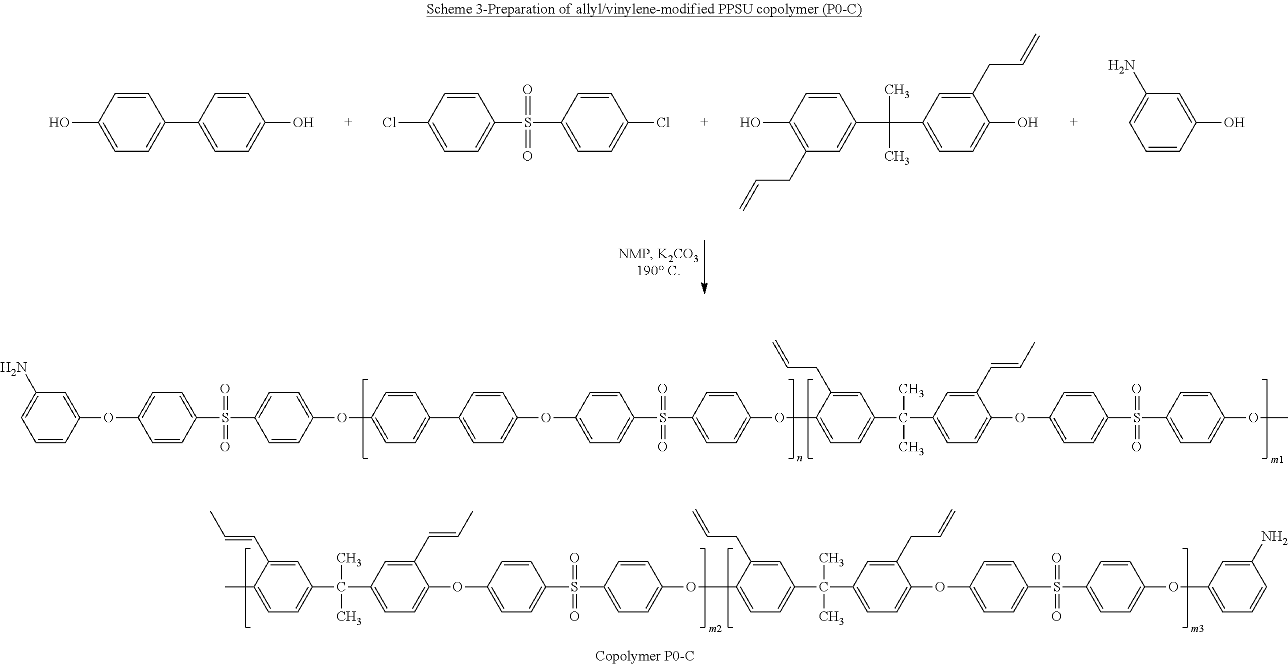

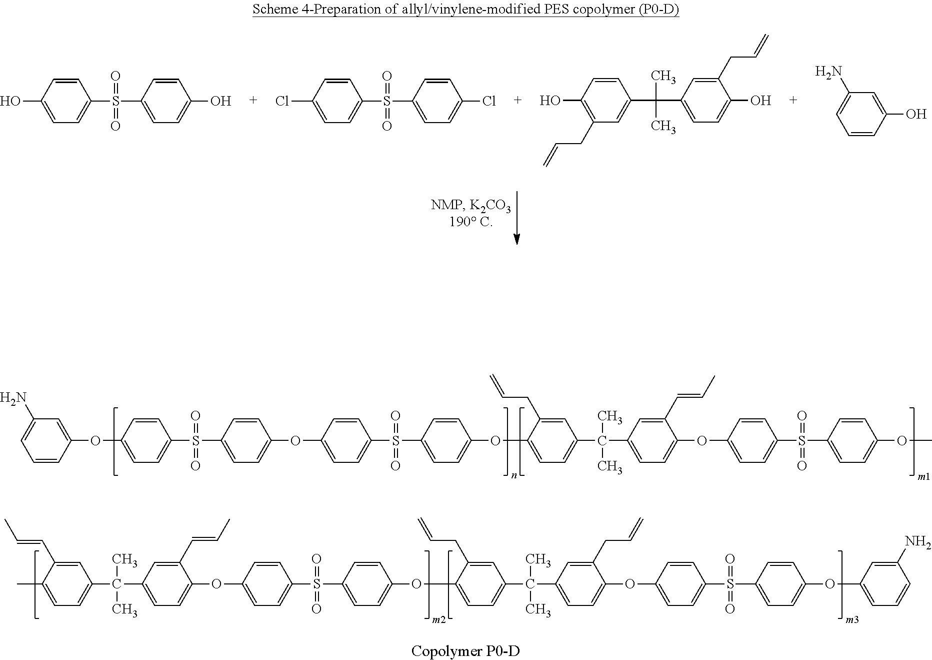

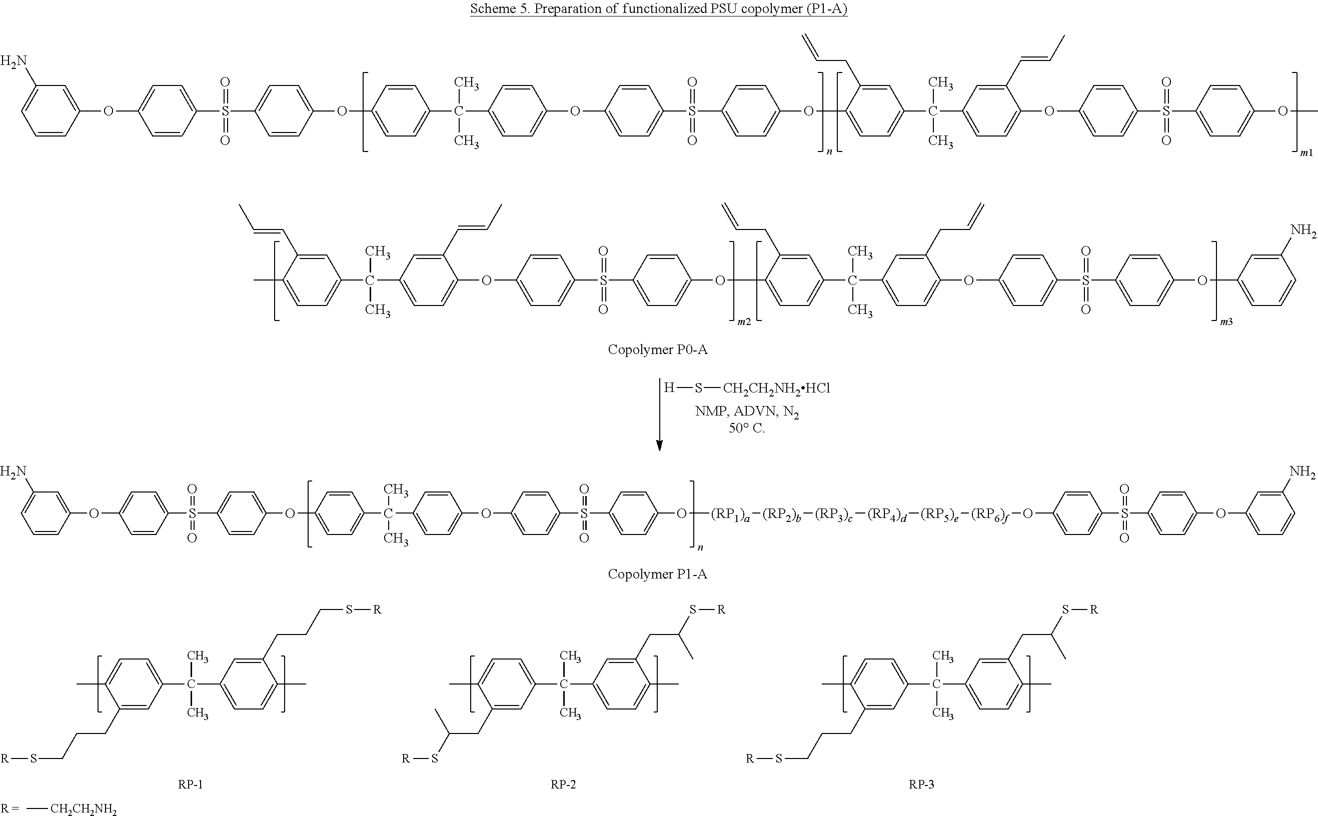

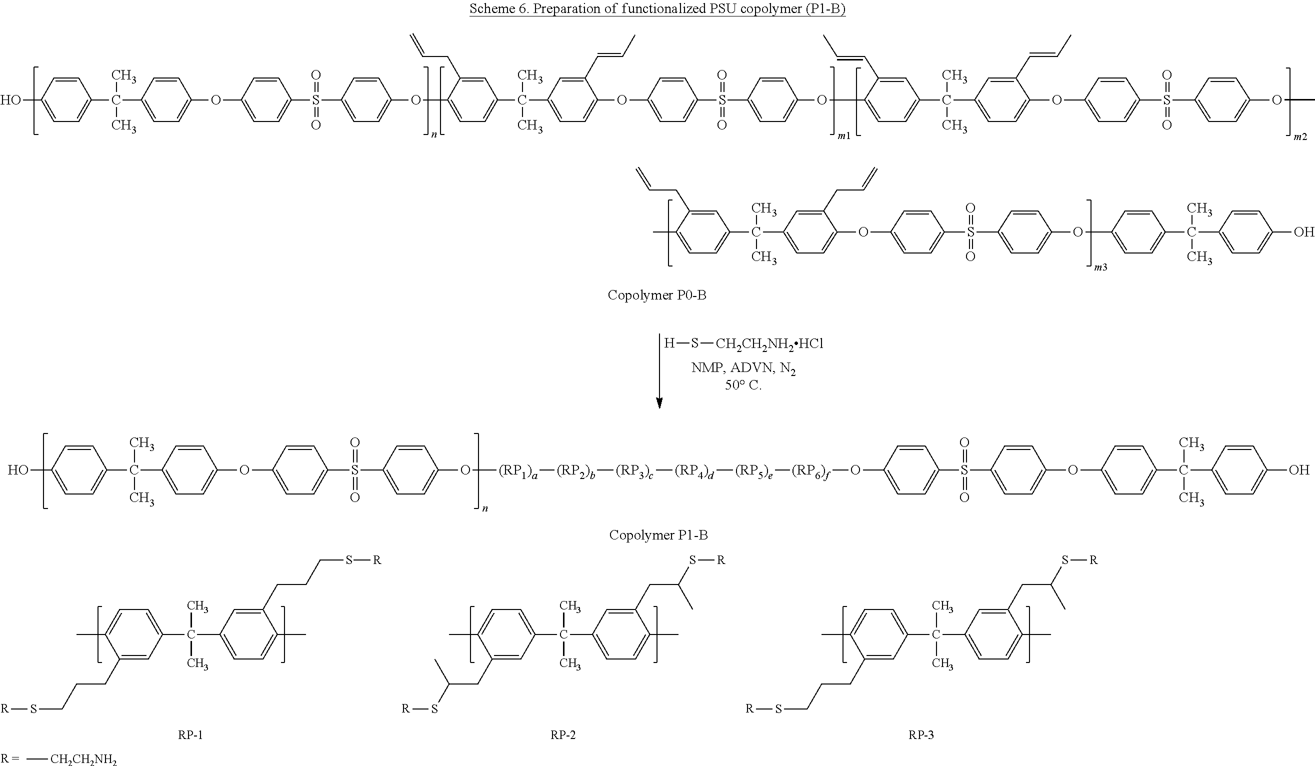

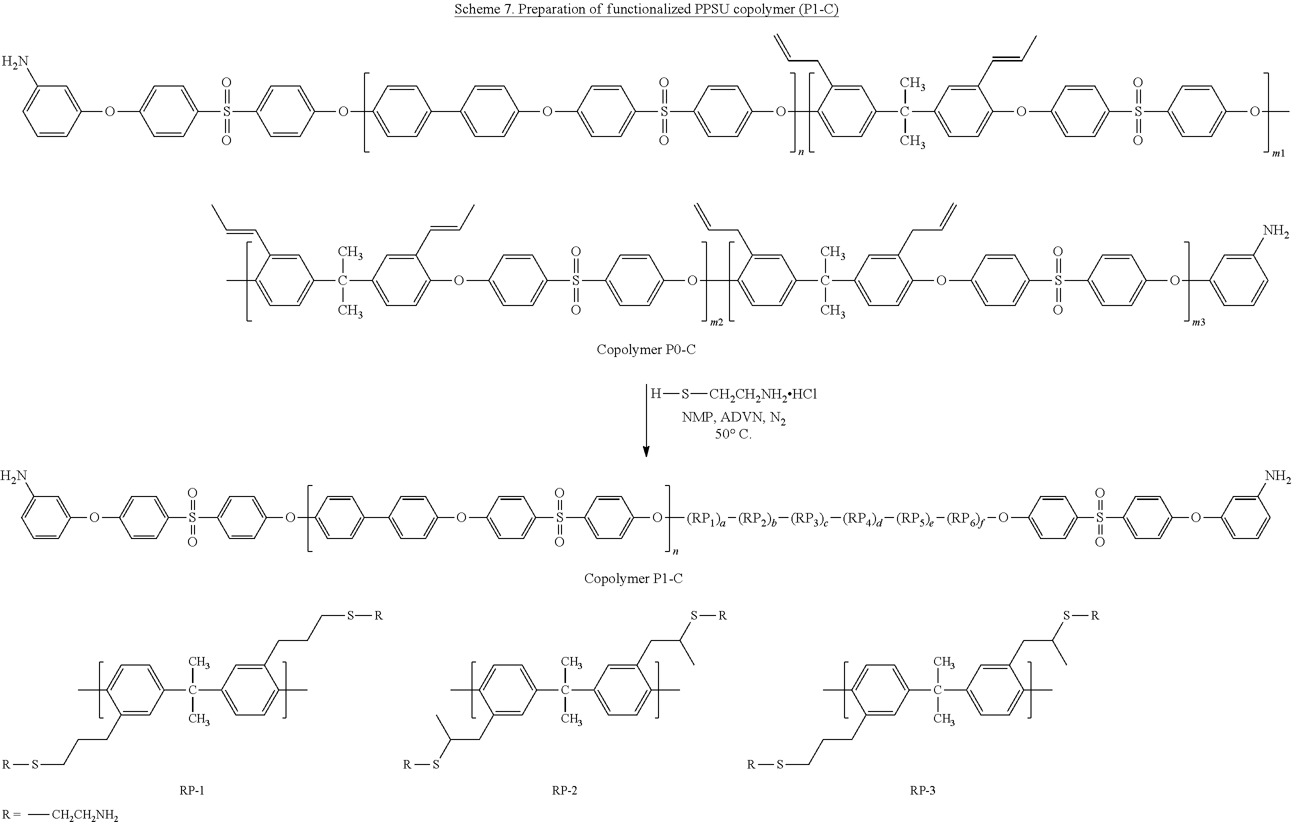

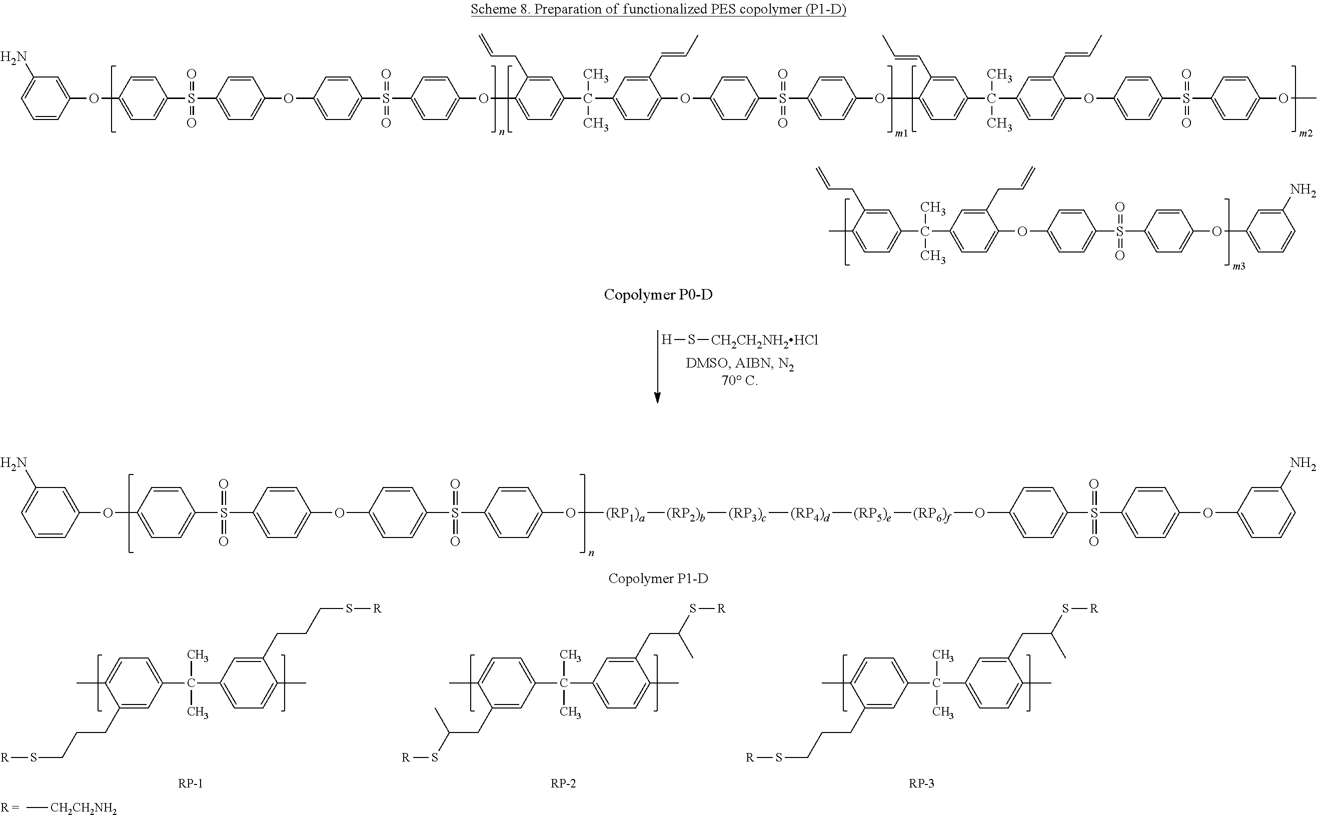

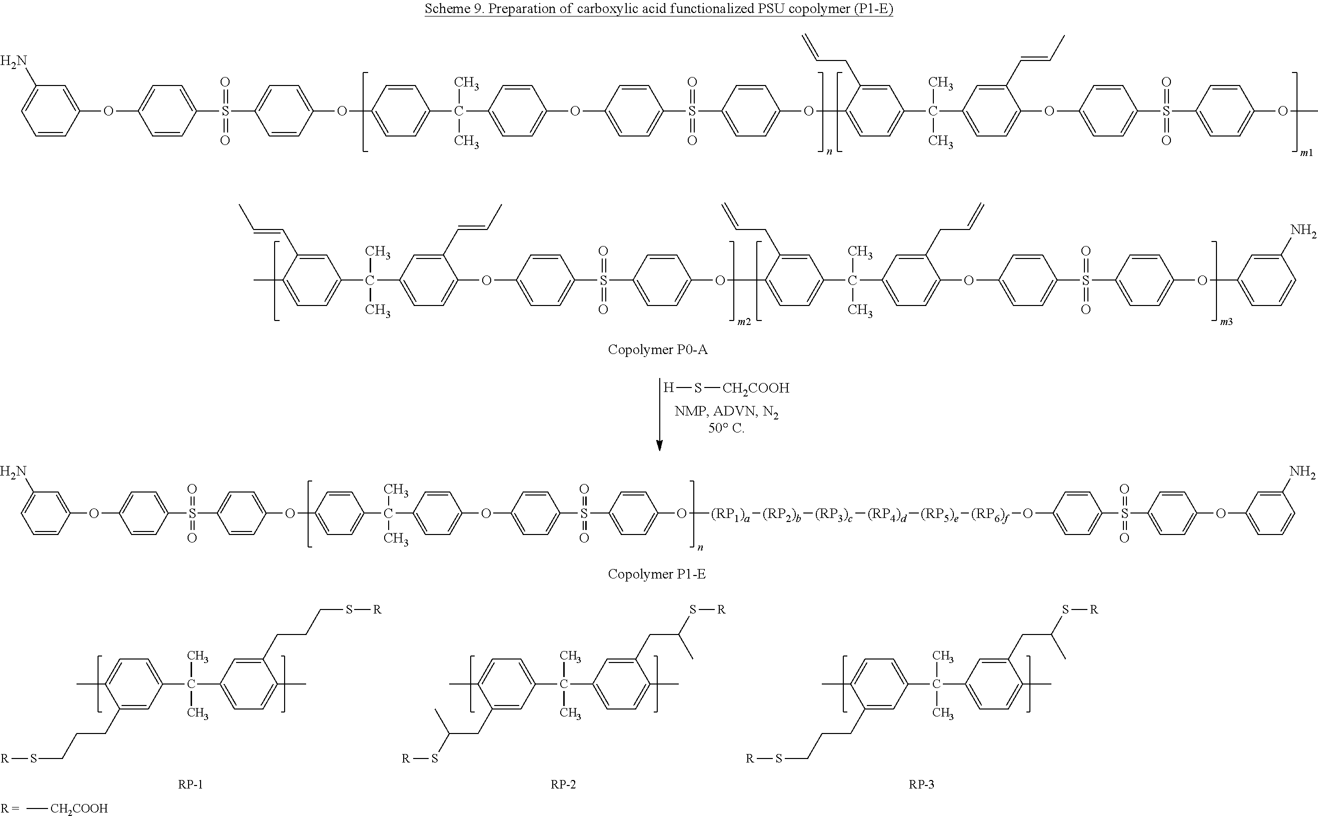

1. A copolymer (P1) comprising:
recurring units (R_{P1}) of formula (M): 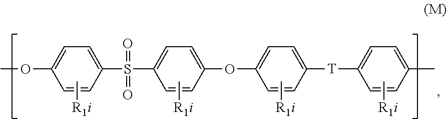
recurring units (R*_{P1}) of formula (N): 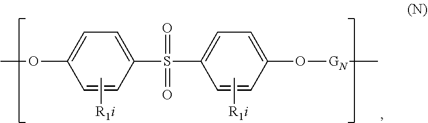
at least 50 μeq of hydroxyl end groups, amine end groups or acid end groups, wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently selected from 0 to 4;
G_{N} is selected from the group consisting of at least one of the following formulas: 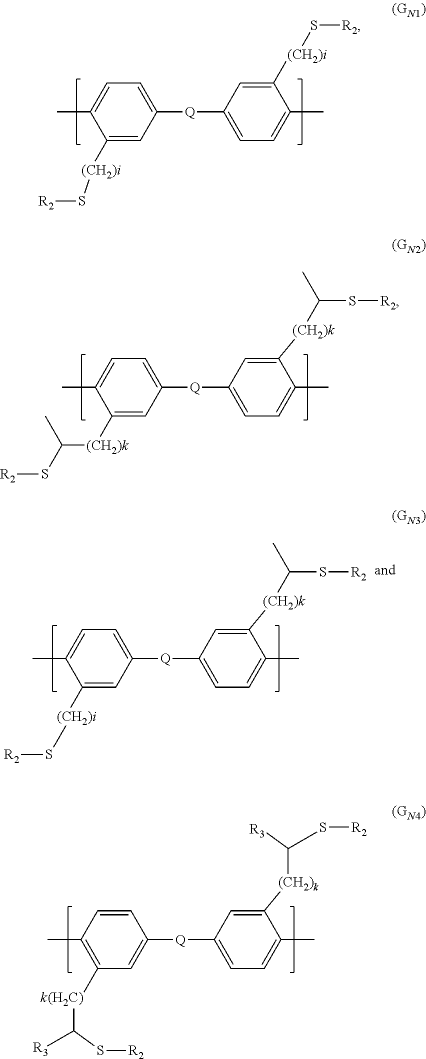
each k is independently selected from 1 to 4;
each j is independently selected from 3 to 7;
T and Q are independently selected from the group consisting of a bond, —CH₂—, —O—; —SO₂—; —S—, —C(O)—, —C(CH₃)₂—; —C(CF₃)₂—; —C(═CCl₂)—, —C(CH₃)(CH₂CH₂COOH)—, —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
each R₂ is independently selected from the group consisting of:
—(CH₂)u-COOH, with u being selected from 1 to 5,
—(CH₂)k-OH, with k being selected from 1 to 5,
—(CH₂)p-NRₐR_{b}, with p being selected from 1 to 5, and Rₐ and R_{b} being independently a C1-C6 alkyl or H, with the proviso that Rₐ and R_{b} cannot be both CH₃,
—(CH₂)q-SO₃Na, with q being selected from 1 to 5,
—(CH₂)a-COCH₃, with a being selected from 0 to 10
—(CH₂)r-Si(OCH₃)₃, with r being selected from 1 to 5,
—(CH₂)s-(CF₂)t-CF₃, with s being selected from 1 to 5 and t being selected from 1 to 10,
—CO—R_{c}, with R_{c} being a C1-C6 alkyl or H,
—(CH₂)v-CH₃, with v being selected from 5 to 30, and
—(CH₂)w-Ar, with w being selected from 0 to 10 and Ar comprising 1 to 10 aromatic or heteroaromatic rings, wherein Ar is optionally substituted with NRₐR_{b},
each R₃ is independently an alkyl group, an aryl group or an halogen group.

2. The copolymer (P1) of claim 1, wherein T in recurring units (R_{P1}) is selected from the group consisting of a bond, —SO₂— and —C(CH₃)₂—.

3. The copolymer (P1) of claim 1, wherein Q in formulas (G_{N1}), (G_{N2}) and/or (G_{N3}) of recurring units (R*_{P1}) is selected from the group consisting of a bond, —SO₂— and —C(CH₃)₂—.

4. The copolymer (P1) of claim 1, wherein i is zero for each R₁ of recurring units (R_{P1}) and recurring units (R*_{P1}).

5. The copolymer (P1) of claim 1, wherein the molar ratio of recurring units (R_{P1})/recurring units (R*_{P1}) varies between 0.01/100 and 100/0.01.

6. The copolymer (P1) of claim 1, wherein recurring units (R_{P1}) are according to formula (M1):

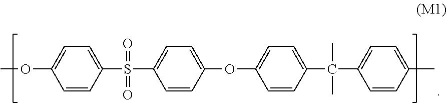

7. The copolymer (P1) of claim 1, wherein R₂ in formulas (G_{N1}), (G_{N2}) or (G_{N3}) is independently selected from the group consisting of:
—CH₂—COOH,
—(CH₂)₂—OH,
—(CH₂)₂—NH₂,
—(CH₂)₃—SO₃Na,
—(CH₂)₃—Si(OCH₃)₃,
—(CH₂)₂—(CF₂)₇CF₃,
—C═O—H,
—(CH₂)₉—CH₃,
—CH₂-Ph, with Ph being benzene, and
-Ph-NH₂, with Ph being benzene.

8. The copolymer (P1) of claim 1, comprising collectively at least 50 mol. % of the recurring units (R_{P1}) and (R*_{P1}), based on the total number of moles in the copolymer (P1).

9. The copolymer (P1) of claim 1, having a number average molecular weight (Mn) of less than 20,000 g/mol, as determined by GPC.

10. A process for preparing a copolymer (P1), comprising reacting in a solvent a copolymer (P0) comprising:
recurring units (R_{P0}) of formula (M): 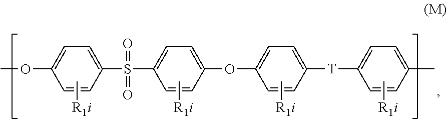
recurring units (R*_{P0}) of formula (P): 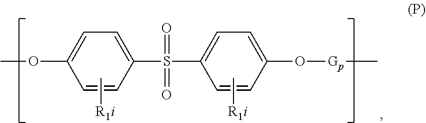
at least 50 μeq of hydroxyl end groups, amine end groups or acid end groups, wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently selected from 0 to 4;
G_{P} is selected from the group consisting of at least one of the following formulas: 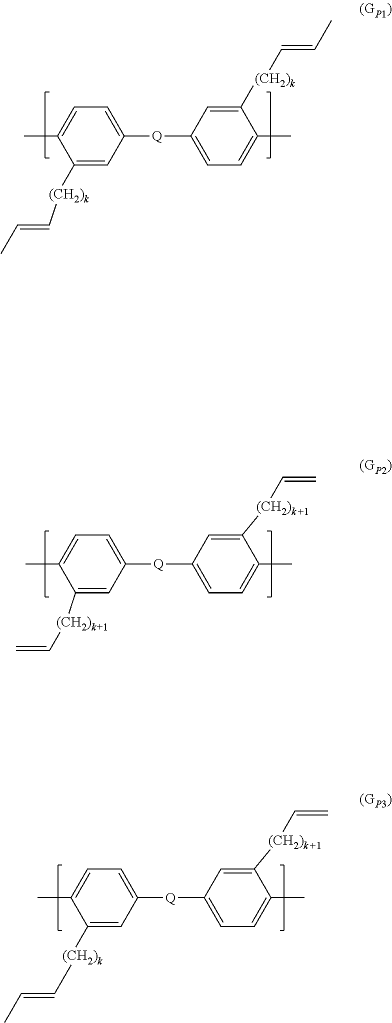
each k is independently selected from 0 to 4,
T and Q are independently selected from the group consisting of a bond, —CH₂—, —O—; —SO₂—; —S—, —C(O)—, —C(CH₃)₂—; —C(CF₃)₂—; —C(═CCl₂)—, —C(CH₃)(CH₂CH₂COOH)—, —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
with a compound of formula (I): R₂—SH
wherein R₂ is selected from the group consisting of:
—(CH₂)u-COOH, with u being selected from 1 to 5,
—(CH₂)k-OH, with k being selected from 1 to 5,
—(CH₂)p-NRₐR_{b}, with p being selected from 1 to 5, and Rₐ and R_{b} being independently a C1-C6 alkyl or H, with the proviso that Rₐ and R_{b} cannot be both CH₃,
—(CH₂)q-SO₃Na, with q being selected from 1 to 5,
—(CH₂)a-COCH₃, with a being selected from 0 to 10
—(CH₂)r-Si(OCH₃)₃, with r being selected from 1 to 5,
—(CH₂)s-(CF₂)t-CF₃, with s being selected from 1 to 5 and t being selected from 1 to 10,
—CO— R_{c}, with R_{c} being a C1-C6 alkyl or H,
—(CH₂)v-CH₃, with v being selected from 5 to 30, and
—(CH₂)w-r, with w being selected from 0 to 10 and Ar comprising 1 to 10 aromatic or heteroaromatic rings, wherein Ar is optionally substituted with NRₐR_{b},
wherein the molar ratio of compound (0/polymer (P0) varies between 0.01/100 and 100/0.01, at a temperature ranging from 10° C. and 300° C.

11. The process of claim 10, being carried out:
in a solvent selected from the group consisting of N-methylpyrrolidone (NMP), N-butylpyrrolidone (NBP), N-ethyl-2-pyrrolidone, 1,3-dimethyl-2-imidazolidinone (DMI), N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole, chloroform, dichloromethane (DCM) and sulfolane,
in the presence of at least one free radical initiator,
in the presence of at least one catalyst, and/or
in the presence of a base.

12. A copolymer (P0) comprising:
recurring units (R_{P0}) of formula (M): 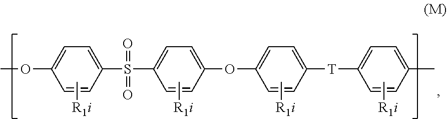
recurring units (R*_{P0}) of formula (P): 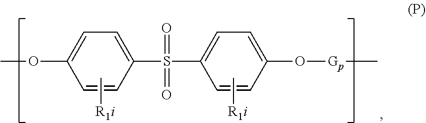
at least 50 μeq of hydroxyl end groups, amine end groups or acid end groups,
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently selected from 0 to 4;
G_{P} is selected from the group consisting of at least one of the following formulas: 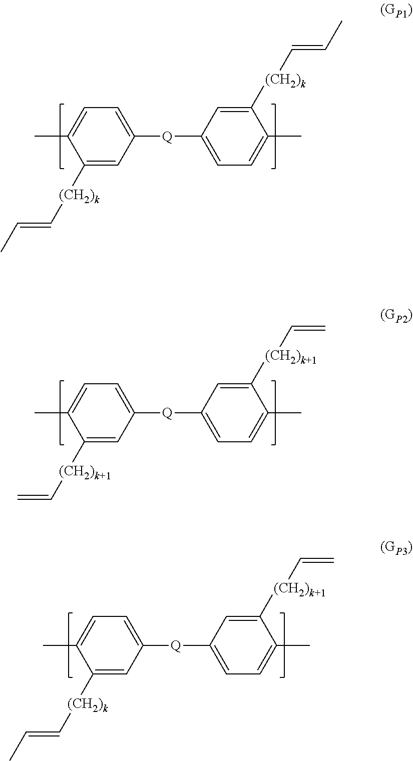
each k is independently selected from 0 to 4,
T and Q are independently selected from the group consisting of a bond, —CH₂—, —O—; —SO₂—; —S—, —C(O)—, —C(CH₃)₂—; —C(CF₃)₂—; —C(═CCl₂)—; —C(CH₃)(CH₂CH₂COOH)—, —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof.

13. A method for the preparation of a membrane, a composite material or a coating, comprising using the copolymer (P1) of claim 1.

14. An epoxy resin composition comprising at least one epoxy compound and at least one copolymer (P1) according to claim 1.

15. The copolymer (P1) of claim 1, being used as a toughening agent in an epoxy, polyurethane or unsaturated polyester resin composition.

16. A method for the preparation of a membrane, a composite material or a coating, comprising using the copolymer (P0) of claim 12.

17. An epoxy resin composition comprising at least one epoxy compound and at least one copolymer (P0) according to claim 12.

18. The copolymer (P0) of claim 12, being used as a toughening agent in an epoxy, polyurethane or unsaturated polyester resin composition.
